(19) United States
(12) Patent Application Publication
(10) Pub. No.: US 2017/0362433 A1
(43) Pub. Date: Dec. 21, 2017

(54) POLYMER BLEND COMPRISING A POLYAMIDE POLYMER, A POLYESTER POLYMER AND AN EPOXY-BASED COMPATIBILIZER

(71) Applicant: Solegear Bioplastics Inc., Vancouver (CA)

(72) Inventors: Richard CHEN, Vancouver (CA); Mirjam MAI, Vancouver (CA); Joanna POOL, Vancouver (CA); Michel LABONTE, Vancouver (CA); Toby REID, Vancouver (CA)

(21) Appl. No.: 15/532,924

(22) PCT Filed: Dec. 4, 2015
(86) PCT No.: PCT/CA2015/051277

§ 371 Date: Jun. 2, 2017

Related U.S. Application Data
(60) Provisional application No. 62/087,577, filed on Dec. 4, 2014.

(51) Int. Cl. C08L 77/06; B29C 47/00; B29C 47/88; C08L 67/04; B29C 45/72; B29C 45/00; B29L 7/00; B29K 67/00; B29K 77/00; B29K 105/00

(52) U.S. Cl. CPC C08L 77/06; B29C 45/72; B29C 47/0004; B29C 47/8805; B29C 47/884; B29C 45/0001; C08L 67/04; B29K 2067/046; B29K 2067/00; B29K 2077/00; B29K 2105/0067; B29L 2007/00; B29L 2007/002; B29L 2007/008; C08L 2205/08; C08L 2205/03

(57) ABSTRACT

This present disclosure relates to durable polymers blends comprising a polyamide polymer, a polyester polymer, and an epoxy-based compatibilizer. The present disclosure further relates to devices, processes, methods and uses involving such polymers.

### FIELD

This present disclosure relates to durable polymers blends. The present disclosure further relates to devices, processes, methods and uses involving such polymers.

### BACKGROUND

Polyamides and polyesters are not typically blended due to differences in flow behavior and material incompatibility. Mixing two or more materials with different flow behavior can cause issues with blending which may result in a weaker material due to, for example, poor energy transfer and imperfections in the polymer matrix. Assuming the absence of a chemical reaction during the mixing, a well-blended and fully compatible system typically has a combination of properties of the individual polymers. However, mixes of two or more polymers are rarely fully compatible and usually have a lower value than the intermediate.

Bio-based polymers such as polylactic acid (PLA) offer an environmentally-friendly alternative to petroleum based plastics due to its renewability and compostability. However, such polymers can suffer from lower performance characteristics. For example, PLA has a relatively low impact resistance and is considered brittle for a number of applications. An article moulded from unmodified PLA will typically be unsuitable for applications that are prone to high contact force such as collision with another hard object. One way to increase the impact of PLA is blend it with a polymer having a higher impact to produce a polymer blend with impact resistance intermediate of the two constituent polymers. This method can be ineffective due to incompatibility of the two polymers.

It would be advantageous to provide a polymer blend which shows acceptable toughness, ductility, stiffness, and chemical resistance.

### SUMMARY

The present disclosure provides, at least in part, a composition comprising a polyamide polymer, a polyester polymer, and an epoxy-based compatibilizer.

The present disclosure provides, at least in part, an article manufactured from present composition, including but not limited to toys, electronic housings, sporting equipments, appliances, automotive parts, furnitures.

The present disclosure provides, at least in part, a process for the production of the present compositions and articles.

As used herein, “a” or “an” means “one or more”.

As used herein, “compatibilizer” means a compound that is utilized as a physical or chemical “bridge” to improve the adhesion of two or more different polymer and/or filler compounds.

This summary does not necessarily describe all features of the invention. Other aspects, features and advantages of the invention will be apparent to those of ordinary skill in the art upon review of the following description of specific embodiments of the invention.

### DETAILED DESCRIPTION

The present disclosure provides, at least in part, a composition comprising a polyamide polymer, a polyester polymer, and an epoxy-based compatibilizer.

Any suitable polyamide or mixture of polyamides may be used herein. One class of polymer polyamide is an aliphatic homopolymer made of lactam monomer units (e.g. polyamide 6, polyamide 11, polyamide 12, etc.) or an aliphatic copolymer of diamine and a dicarboxylic acid monomers (e.g. polyamide 66, polyamide 610, polyamide 1010, polyamide 1012, etc.). This class is often considered for use in high performance engineering resins such as those for high end plastic applications such as automotive, appliances, machineries.

The present compositions may comprise from about 95% or less, about 80% or less, about 70% or less, about 60% or less, by weight of the total composition, of polyamide.

The present compositions may comprise from about 5% or greater, about 20% or greater, about 30% or greater, about 40% or greater, by weight of the total composition, of polyamide.

Polyamide with a crystalline melting temperature of about 160° C. or higher, about 165° C. or higher, about 175° C. or higher, about 190° C. or higher may be used herein. Preferably the crystalline melting temperature of the polyamide does not exceed about 210° C.

In certain embodiments, polyamide polymer that is polymerized from lactam monomer(s), diamine monomer(s), and dicarboxilic acid monomer(s), where one or more of the monomeric constituents may comprise of 6 carbon atoms or more, 8 carbon atoms or more, 10 carbon atoms or more, but not more than 12 carbon atoms, chemically linked together in a linear or aliphatic form may be used herein.

Present compositions may comprise of polyamides produced from 0%, more preferably 20%, more preferably 40%, more preferably 60%, more preferably 80%, more preferably 99%, but not exceeding 100% renewable resources as tested by ASTM D6866.

Any suitable polyester or mixture of polyester may be used herein. For example, polyesters with aliphatic or aliphatic and aromatic moieties may be used. The polyester is preferably produced from bio-based feedstock (testable by ASTM D6866) such as polylactic acid, polyhydroxy alkanoates, polybutylene succinate, polybutylene succinate-co-adipate, or polybutylene succinate-co-lactate. The polyester may be produced from petroleum feedstock such as polycaprolactone, polybutylene adipate-co-terephthalate, polyethylene terephthalate, polytrimethylene terephthalate, or polybutylene terephthalate.

The terms “polylactic acid”, “polylactide” and “PLA” are used interchangeably to include homopolymers and copolymers of lactic acid and lactide based on polymer characterization of the polymers being formed from a specific monomer or the polymers being comprised of the smallest repeating monomer units. Polylactide is a dimeric ester of lactic acid and can be formed to contain small repeating monomer units of lactic acid (actually residues of lactic acid) or be manufactured by polymerization of a lactide monomer, resulting in polylactide being referred to both as a lactic acid residue containing polymer and as a lactide residue containing polymer. It should be understood, however, that the terms “polylactic acid”, “polylactide”, and “PLA” are not necessarily intended to be limiting with respect to the manner in which the polymer is formed. Suitable lactic acid and lactide polymers include those homopolymers and copolymers of lactic acid and/or lactide which have a weight average molecular weight generally ranging from about 10,000 g/mol to about 600,000 g/mol, from about 30,000 g/mol to about 400,000 g/mol, or from about 50,000 g/mol to about 200,000 g/mol. Commercially available polylactic acid polymers which may be useful herein include a variety of polylactic acids that are available from the Chronopol Incorporation located in Golden, Colo., and the polylactides sold under the tradename EcoPLA®. Examples of suitable commercially available polylactic acid are NATUREWORKS® from Cargill Dow and LACEA® from Mitsui Chemical. Modified polylactic acid and different stereo configurations may also be used, such as poly D-lactic acid, poly L-lactic acid, poly D,L-lactic acid, and combinations thereof.

The present compositions may comprise from about 95% or less, about 80% or less, about 70% or less, about 60% or less, by weight of the total composition, of polyester.

The present compositions may comprise from about 5% or greater, about 20% or greater, about 30% or greater, about 40% or greater, by weight of the total composition, of polyester.

Any suitable compatibilizer or mixture of compatibilizers may be used herein. Multifunctional epoxy based compatibilizers, that is a compatibilizer with two or more reactive functional epoxy groups, may be produced from monomer(s) containing glycidyl side chains with reactive epoxy functionality. One of such monomer is glycidyl methacrylate which is typically polymerized or grafted through free radical reaction with other monomers such as styrene or ethylene or polymers such as polystyrene and polyethylene. The glycidyl side chains undergo a reaction with available hydroxyl, carboxylic acid, and/or amine functionalities to produce a covalent bond between the compatibilizer and the hydroxyl, carboxylic acid, and/or amine containing compounds.

The present compositions may comprise from about 0.01% or greater, about 0.05% or greater, about 0.1% or greater, about 0.5% or greater, by weight of the total composition, of compatibilizer.

The present compositions may comprise from about 20% or less, about 10% or less, about 5% or less, about 3% or less, about 1% or less, by weight of the total composition, of compatibilizer.

The compatibilizer used may be in polymeric form, with one or more monomers such as but not limited to, styrene, acrylonitrile, butadiene, glycidyl methacrylate, ethylene, methyl acrylate, ethyl acrylate, butyl acrylate.

The present polymer blend may be produced in any suitable manner. For example, the present polymer blend may be produced by mixing the components together through melt extrusion process performed at temperature range above the melting temperature of the highest component in the system.

While not wishing to be bound by theory, it is believed that the present compositions can have greater toughness and ductility over the individual polymers. The present compositions may show improved stiffness over polyamide polymers alone. The present compositions may show improved chemical resistance of polyester polymers alone. The improved properties are believed to be due to the compatibilizer producing a chemical “bridge” between the two other polymer components. This compatibilizer may also assist in the processing of the material by creating a material that reduces the flow differences in the two materials, which reduces phase separation during the melt mixing, allowing for easier extrusion and molding process with a larger processing temperature window. Thus, the present blends may exhibit properties better than a simple mixture of the polyester and polyamide. Additionally some blends have even been observed to have improved properties over the starting polyamide which is significant considering the starting polyamide resin is viewed as a high performance engineering thermoplastic.

The present compositions may comprise from about 1% or greater, about 40% or greater, about 60% or greater, about 70% or greater, by weight of the total composition, of PLA.

The present compositions may comprise from about 99% or less, about 95% or less, about 90% or less, about 85% or less, by weight of the total composition, of PLA.

The present compositions may comprise a variety of optional ingredients. The present compositions may comprise an impact modifier. Any suitable impact modifier may be used such as, for example, polyether-block-amide copolymers. The present impact modifier may be selected from, for example, PEBAX Rnew 55R53 (Arkema) and PEBA E55-S3 (Evonik), or the like. In certain embodiments the present compositions comprise from about 0.1% to about 20%, from about 1% to about 15%, from about 5% to about 10%, by weight, of impact modifier. The present compositions may comprise a plasticizer. Any suitable plasticizer may be used such as, for example, triethyl citrate, tributyl citrate, glycerol, lactic acid monomer and oligomer. In certain embodiments the present compositions comprise from about 0.01% to about 20%, from about 0.1% to about 10%, from about 0.5% to about 8%, from about 0.8% to about 5%, from about 1% to about 4%, by weight, of plasticizer.

Other optional materials include, for example, processing aids to modify the processability and/or to modify physical properties such as elasticity, tensile strength and modulus of the final product. Other optional materials may include, but are not limited to, those which provide stability including oxidative stability, brightness, color, flexibility, resiliency, workability, processing aids, viscosity modifiers, and odor control.

The present compositions may comprise a polymer nucleating agent to increase polymer crystallinity, improving thermo-mechanical properties of the product. Any suitable nucleating agent may be used such as, for example, talc, calcium carbonate, carbon black, bentonite, clay, salts, silica, metal salts of phosphonates, titanium dioxide, cellulose fibers, and mixtures thereof.

Examples of other optional ingredients include, but are not limited to, calcium carbonate, gum arabic, bentonite, salts, slip agents, crystallization accelerators or retarders, odor masking agents, cross-linking agents, emulsifiers, surfactants, cyclodextrins, lubricants, other processing aids, optical brighteners, antioxidants, flame retardants, dyes, pigments, fillers, proteins and their alkali salts, waxes, tackifying resins, extenders, chitin, chitosan, and mixtures thereof. Suitable optional fillers include, but are not limited to, clays, silica, mica, wollastonite, calcium hydroxide, sodium carbonate, magnesium carbonate, barium sulfate, magnesium sulfate, kaolin, calcium oxide, magnesium oxide, aluminum hydroxide, talc, titanium dioxide, cellulose fibers, chitin, chitosan powders, organosilicone powders, nylon powders, polyester powders, polypropylene powders, starches, and mixtures thereof. When used, the amount of filler is generally from about 0.01% to about 60% by weight of the composition.

In certain embodiments, the present disclosure provides a material having a notched izod impact resistance as measured by ASTM D256 of about 35 J/m or greater, about 40 J/m or greater, about 50 J/m or greater, about 60 J/m or greater, about 70 J/m or greater, about 80 J/m or greater, about 90 J/m or greater, about 100 J/m or greater.

In certain embodiments, the ppresent disclosure provides a material having a tensile elongation at break as measured by ASTM D638 of about 50% or greater, about 100% or greater, about 150% or greater, about 200% or greater, about 250% or greater.

In certain embodiments, the ppresent disclosure provides a material having a flexural strength as measured by ASTM D790 of about 40 MPa or greater, about 45 MPa or greater, about 50 MPa or greater, about 55 MPa or greater, about 60 MPa or greater.

In certain embodiments, the ppresent disclosure provides a material having a flexural modulus as measured by ASTM D790 of about 1.2 GPa or greater, about 1.5 GPa or greater, about 1.8 GPa or Greater, about 2.0 GPa or greater, about 2.5 GPa or greater.

The compositions herein may be used to form a molded or extruded article. As used herein, a “molded or extruded article” is an object that is formed using molding or extrusion techniques such as injection molding, blow molding, thermoforming, compression molding or extrusion of pipes, tubes, profiles, cables, or films. Molded or extruded articles may be solid objects such as, for example, toys, or hollow objects such as, for example, bottles, containers, tampon applicators, applicators for insertion of medications into bodily orifices, medical equipment for single use, surgical equipment, or the like. See Encyclopedia of Polymer Science and Engineering, Vol. 8, pp. 102-138, John Wiley and Sons, New York, 1987 for a description of injection, compression, thermoforming and blow molding. See Hensen, F., Plastic Extrusion Technology, p 43-100 for a description of extrusion processes.

It is contemplated that the different parts of the present description may be combined in any suitable manner. For instance, the present examples, methods, aspects, embodiments or the like may be suitably implemented or combined with any other embodiment, method, example or aspect of the invention.

Unless defined otherwise, all technical and scientific terms used herein have the same meaning as is commonly understood by one of ordinary skill in the art to which this invention belongs. Unless otherwise specified, all patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference. Citation of references herein is not to be construed nor considered as an admission that such references are prior art to the present invention.

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

### Examples

All materials were compounded in a twin-screw extruder and injection moulded to form test bars as per ASTM D256, D638, and D790. Tensile test was conducted based on ASTM D638, flexural test was conducted based on ASTM D790, and Izod notched impact was conducted based on ASTM D256. Polylactic acid (PLA) used is an extrusion grade semi-crystalline polylactic acid with relatively high molecular weight and relatively low melt flow index such as the Ingeo 2003D grade from Natureworks LLC. Polyamide used is a polyamide 10,12 (PA1012) produced from the polycondensation of 1,10-decamethylene diamine and 1,12-dodecanedioic acid such as Vestamid Terra DD from Evonik AG. The compatibilizer used is a styrene-glycidyl methacrylate copolymer such as Joncryl ADR 4368 from BASF SE.

The base materials show that PLA and PA1012 are at opposing ends of the spectrum in terms of material properties. PLA is stiff and rigid with high modulus, strength, and low elongation and Izod notched impact whereas PA1012 is soft and flexible with low modulus, very high elongation at break and Izod notched impact. PA1012 also undergoes yield and stress induced crystallization, making it stronger when the material is stretched which is a phenomena that is not observable with PLA.

Tests 9 and 10 show the difference between uncompatibilized (9) and compatibilized (10) formulations. The compatibilized material shows higher impact resistance, which is a trend that can be extended to the remaining formulations.

Theoretically, blended polymers without the occurrence of a chemical reaction would have properties that are in the range of the two polymers. For example, tensile modulus is generally in the range of 0.61-1.39 GPa, yield strength is generally in the range of 40.7-57.2 MPa, and elongation at break is generally in the range of 5.7-286.5%. A compatible blend of 70% Polyamide and 30% PLA would have a theoretical tensile modulus of 0.84 GPa, tensile strength at yield of 46 MPa, and a theoretical elongation at break of 202%. The resulting experimental blend at 70% polyamide and 30% PLA with 0.1 phr compatibilizer (formulation 7), has 0.85 GPa for tensile modulus, 44.1 MPa for tensile strength at yield, and an elongation at break of 335%. While the tensile strength at modulus and tensile strength at yield is very near in value to its theoretical counterpart, the elongation exceeds what is theoretically possible.

Furthermore, the notched Izod impact property of formulation 6 and 7 exceeded the value that was measured for both PA1012 (formulation 2) and PA1012 with compatibilizer (formulation 4) after the addition of PLA. The addition of PLA, which is brittle, would be expected to produce a brittle material rather than a more ductile and stronger material.

| | PLA | | | | Tensile | Tensile | | | | | Impact |
|---|---|---|---|---|---|---|---|---|---|---|---|
| | Ingeo | PA | | Tensile | Strength | Strength | Elongation | Elongation | Flexural | Flexural | Izod |
| | 3251D | DD16 | SGMA | Modulus | @ Break | @ Yield | @ yield | @ Break | Strength | Modulus | Notched |
| | (%) | (%) | (phr) | (GPa) | (MPa) | (MPa) | (%) | (%) | (MPa) | (GPa) | (J/m) |
| 1* | 100 | | | 1.39 | 53.8 | 57.2 | 5.1 | 5.7 | 94.7 | 3.11 | 23.7 |
| 2* | | 100 | | 0.61 | 51.1 | 40.7 | 39.7 | 286.5 | 34.9 | 1.13 | 61.7 |
| 3* | 100 | | 1 | 1.27 | 56.6 | 63.6 | 6.1 | 9.2 | 97.8 | 3.01 | 24.4 |
| 4* | | 100 | 1 | 0.61 | 49.3 | 42.7 | 8.6 | 196.5 | 44.2 | 1.21 | 87.6 |
| 5 | 90 | 10 | 1 | 1.23 | 60.2 | 62.1 | 7.5 | 8.2 | 89.7 | 3.02 | 24.6 |
| 6 | 10 | 90 | 1 | 0.62 | 53.8 | 55.7 | 7.2 | 241.9 | 46.2 | 1.22 | 124.8 |
| 7 | 30 | 70 | 0.1 | 0.85 | 45.1 | 44.1 | 6.9 | 335.2 | 62.1 | 1.57 | 70.2 |
| 8 | 70 | 30 | 5 | 1.13 | 50.2 | 56.8 | 6.3 | 367.1 | 75.5 | 2.32 | 24.7 |
| 9* | 57 | 43 | | 0.94 | 30.3 | 45.5 | 6.6 | 292.6 | 59.4 | 2.05 | 21.6 |
| 10 | 57 | 43 | 4 | 1.04 | 62.9 | 53.5 | 6.7 | 416.9 | 68.6 | 2.30 | 45.4 |

1. A composition comprising a polyamide polymer, a polyester polymer, and an epoxy-based compatibilizer.

2. The composition of claim 1 comprising at least about 10% by weight of polyester.

3. The composition of claim 1 comprising at least about 10% by weight of polyamide.

4. The composition of claim 1 wherein the composition polyester comprises polylactic acid.

5. The composition of claim 1 wherein the composition polyamide is a long chain polyamide with monomers containing 10 or more linear carbon atoms.

6. The composition of claim 1 wherein the polyamide is an aliphatic homopolymer made of lactam monomer units, an aliphatic copolymer of diamine and a dicarboxylic acid monomers, or combinations thereof.

7. The composition of claim 1 comprising from about 10% to about 99% by weight of polyester and from about 10% to about 99% by weight of polyamide.

8. The composition of claim 1 wherein the epoxy-based compatibilizers are produced from monomer(s) containing glycidyl side chains with reactive epoxy functionality.

9. The composition of claim 1 wherein the epoxy-based compatibilizers are produced from monomers having glycidyl methacrylate side-chains.

10. An article formed from the composition according to claim 1.

11. The article according to claim 11 wherein said article has elongation at break as measured by ASTM D-638 of about 50% or greater.

12. The article according to claim 11 wherein said article has a notched izod impact resistance as measured by ASTM D256 of about 40 J/m or greater.

13. The article according to claim 11 wherein said article has flexural modulus as measured by ASTM D-790 of about 1.5 GPa or greater.

14. A method of producing an article, the method comprising:
(a) providing a composition according to claim 1;
(b) heating said composition to a temperature above its melt temperature;
(c) extruding said composition into a film or sheet;
(d) placing the heated film or sheet in a mould; and
(e) cooling to below melt temperature

15. A method of producing an article, the method comprising:
(a) providing a composition according to claim 1;
(b) heating said composition to a temperature above its melt temperature; and
(c) injection moulding said composition to form said article.
